(19) United States
(12) Patent Application Publication
(10) Pub. No.: US 2024/0424690 A1
(43) Pub. Date: Dec. 26, 2024

(54) GRIPPING MECHANISM AND MOBILE ROBOT

(71) Applicants: Sheng-Kai Lai, Taipei City (TW); Wen-Yi Kuo, Taipei City (TW); Wen-Hsiang Chen, Taipei City (TW); Chen-Wei Yang, Taipei City (TW); Ting-Cheng Sun, Taipei City (TW)

(72) Inventors: Sheng-Kai Lai, Taipei City (TW); Wen-Yi Kuo, Taipei City (TW); Wen-Hsiang Chen, Taipei City (TW); Chen-Wei Yang, Taipei City (TW); Ting-Cheng Sun, Taipei City (TW)

(73) Assignee: Unicom Global, Inc., Taipei City (TW)

(21) Appl. No.: 18/748,133

(22) Filed: Jun. 20, 2024

Related U.S. Application Data
(60) Provisional application No. 63/522,118, filed on Jun. 20, 2023.

(51) Int. Cl. B25J 15/00; B25J 5/00

(52) U.S. Cl. CPC B25J 15/0028; B25J 5/007

(57) ABSTRACT

Disclosed is a gripping mechanism including a first bracket, a second bracket, a first guide rod, a third bracket, an actuating module, a gripping block and two grippers. The second bracket is connected to the first bracket. The third bracket is connected to the second bracket. The actuating module is disposed on the third bracket. The gripping block is slidably disposed on the third bracket and is connected to the actuating module. The two grippers are fixed on the terminal end of the third bracket distal from the first bracket and the second bracket, wherein the gripping block is located between the actuating module and the two grippers and the actuating module is adapted to drive the gripping block to slide close to or slide away from the two grippers. A mobile robot is also disclosed.

### CROSS-REFERENCE TO RELATED APPLICATION

This application claims the priority benefit of U.S. provisional application Ser. No. 63/522,118, filed on Jun. 20, 2023. The entirety of the above-mentioned patent application is hereby incorporated by reference herein and made a part of this specification.

### BACKGROUND

### Technical Field

The present disclosure relates to a robot, and in particular to a gripping mechanism and a mobile robot.

### Description of Related Art

Because of problems such as manpower shortage and increased labor costs, automated factories, automated warehousing, automated logistics centers or other automated fields have been established to accurately transport target objects to destinations by mobile robots according to pre-planned paths or autonomous navigation. In this way, it is possible to significantly reduce manpower deployment and even achieve unmanned deployment.

Generally speaking, a mobile robot is able to fix a target object through a hooking mechanism or a gripping mechanism, and carry out the action of transporting the target object. However, there might be uneven terrain at the field where the mobile robot is located, and the target object might be accidentally detached from the hooking mechanism or gripping mechanism due to impact, obstruction, vibration or other external forces or objects during transportation, which results in decline of efficiency and poor reliability of automated transportation.

### SUMMARY

The present disclosure provides a gripping mechanism and a mobile robot that are able to prevent target objects from being accidentally detached during transportation.

The present disclosure provides a gripping mechanism, including a first bracket, a second bracket, a first guide rod, a third bracket, an actuating module, a gripping block and two grippers. The second bracket is connected to the first bracket. The third bracket is connected to the second bracket. The actuating module is disposed on the third bracket. The gripping block is slidably disposed on the third bracket and connected to the actuating module. The two grippers are fixed on the terminal end of the third bracket distal from the first bracket and the second bracket, wherein the gripping block is located between the actuating module and the two grippers, and the actuating module is adapted to drive the gripping block to slide close to or away from the two grippers.

In an embodiment of the present disclosure, the two grippers are arranged in parallel on the terminal end of the third bracket distal from the first bracket and the second bracket, and the distance between the two grippers is greater than the width of the gripping block.

In an embodiment of the present disclosure, the gripping block includes a body connected to the actuating module and a bump detachably fixed on the body, and the bump is disposed between the body and two grippers.

In an embodiment of the present disclosure, the extending direction of the bump is perpendicular or parallel to the parallel direction of the two grippers.

In an embodiment of the present disclosure, the gripping mechanism further includes a first guide rod fixed on the second bracket. The second bracket is pivotally connected to the first bracket, and the third bracket is slidingly connected to the first guide rod. The actuating module is disposed between the first guide rod and the gripping block, wherein the third bracket is adapted to slide along the first direction, and the actuating module is adapted to drive the gripping block to slide along the second direction perpendicular to the first direction.

In an embodiment of the present disclosure, the actuating module includes an actuating push rod, a first driven rod and a second driven rod. The actuating push rod is pivotally connected to the third bracket. Two ends of the first driven rod are respectively pivotally connected to the actuating push rod and the third bracket, and two ends of the second driven rod are respectively pivotally connected to the first driven rod and the gripping block.

In an embodiment of the present disclosure, a connection line between the pivot axis of the first driven rod on the third bracket and the pivot axis of the second driven rod on the gripping block is parallel to the second direction.

In an embodiment of the present disclosure, a connection line between the pivot axis of the first driven rod on the third bracket and the pivot axis of the second driven rod on the gripping block is higher than the pivot axis of the second bracket on the first bracket.

In an embodiment of the present disclosure, the gripping mechanism further includes a second guide rod fixed on the third bracket, wherein the gripping block is slidably connected to the second guide rod, and the first guide rod is perpendicular to the second guide rod.

In an embodiment of the present disclosure, the gripping mechanism further includes a compression spring sleeved on the first guide rod, wherein two ends of the compression spring are in contact with the second bracket and the third bracket respectively.

In an embodiment of the present disclosure, the gripping mechanism further includes a tension spring, wherein two ends of the tension spring are respectively connected to the first bracket and the second bracket, and two ends of the second bracket are respectively connected to the tension spring and pivotally connected to the first bracket.

In an embodiment of the present disclosure, the gripping mechanism further includes a screw and an adjusting bracket, wherein the adjusting bracket is screwed to the first bracket through the screw, and the tension spring is connected to the first bracket through the adjusting bracket.

In an embodiment of the present disclosure, the gripping mechanism further includes a sensor fixed on the gripping block, and the sensor faces the two grippers.

The present disclosure provides a mobile robot, including a moving body, a rotating lifting arm and the gripping mechanism. The first bracket of the gripping mechanism is pivotally connected to the rotating lifting arm.

Based on the above, when the mobile robot is transporting the target object, the gripping block and the two grippers in the gripping mechanism are able to firmly grasp the target object to prevent the target object from being accidentally detached from the gripping mechanism.

In order to make the above-mentioned features and advantages of the present disclosure more clear and easy to understand, embodiments are specifically cited below and are described in detail below with reference to the accompanying drawings.

### BRIEF DESCRIPTION OF THE DRAWINGS

FIG. 1A and FIG. 1B are schematic views of a mobile robot viewed from two different perspectives according to an embodiment of the present disclosure.

FIG. 2A and FIG. 2B are schematic views of the gripping mechanism of FIG. 1A and

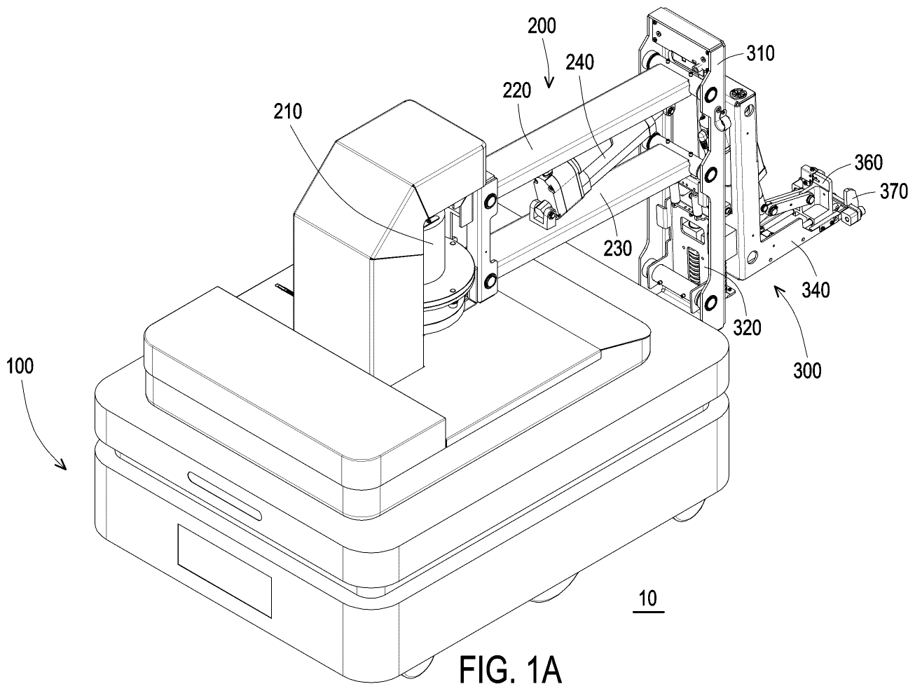

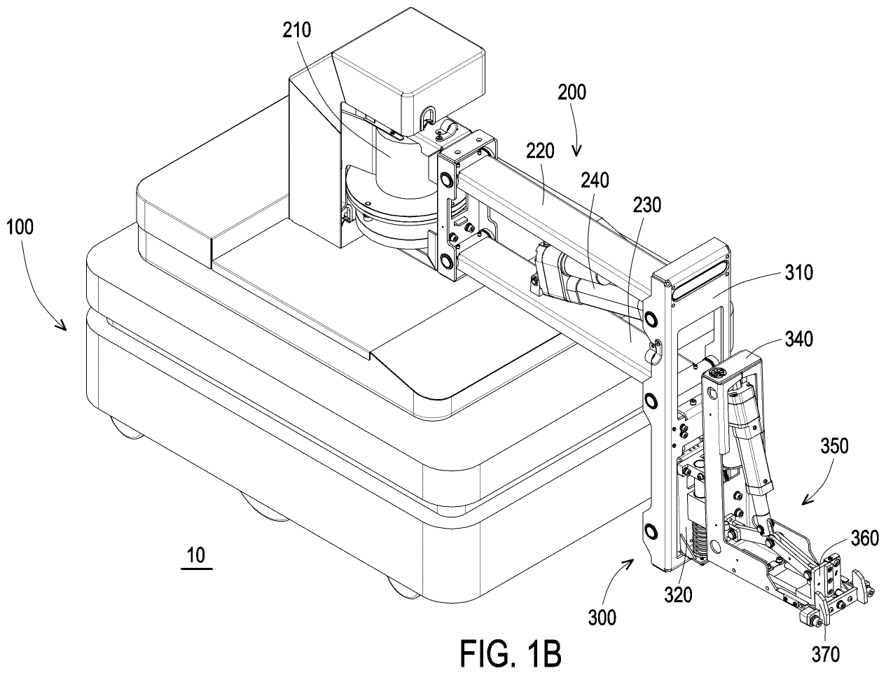

FIG. 1B respectively.

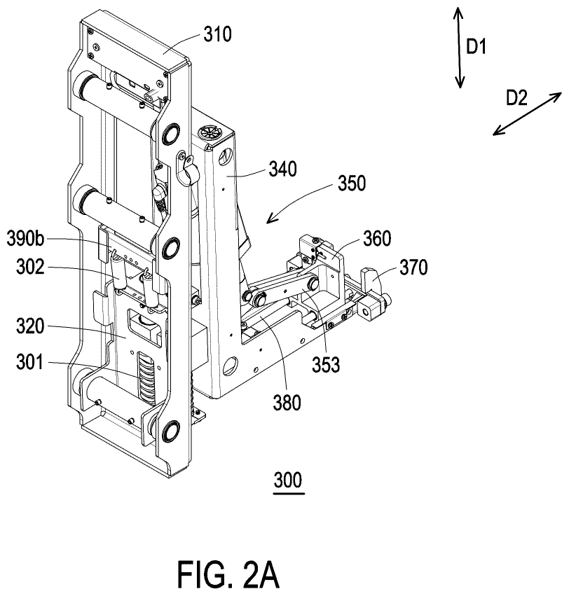

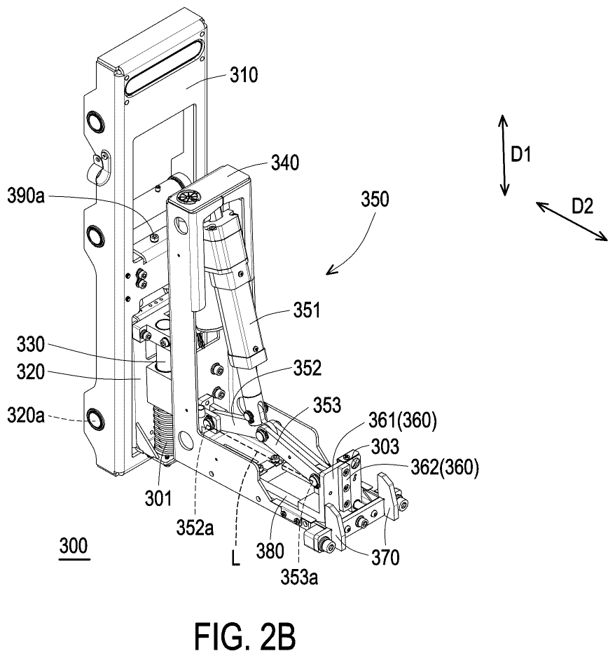

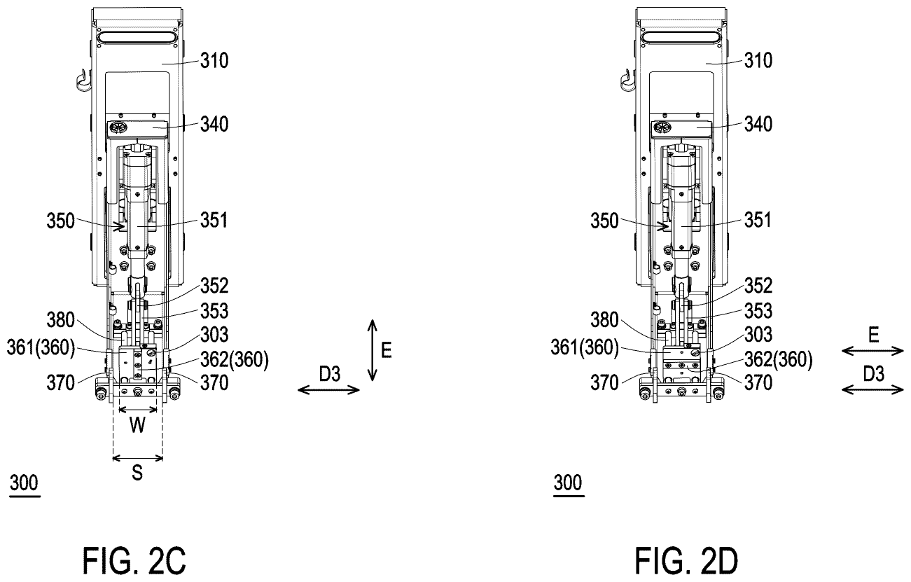

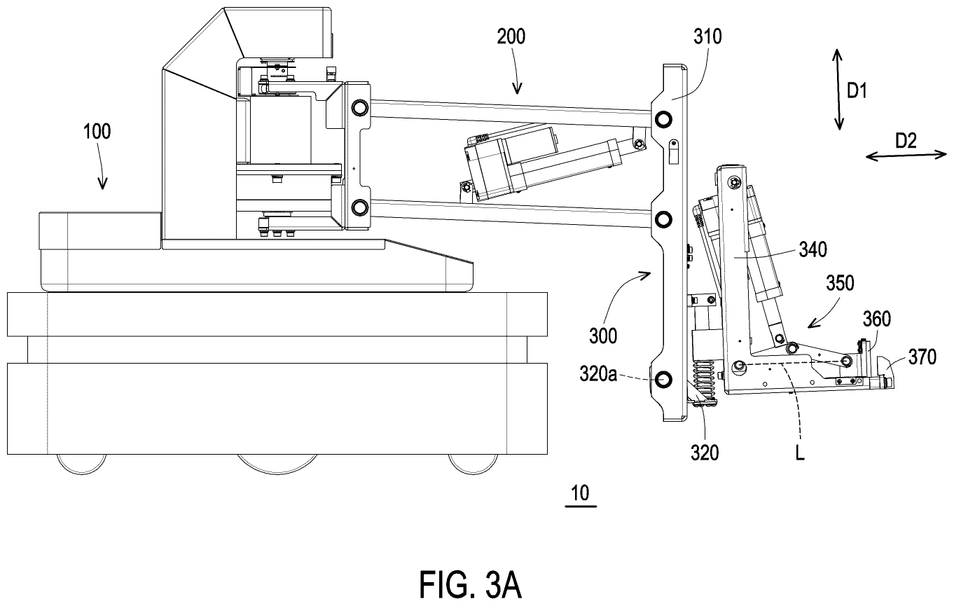

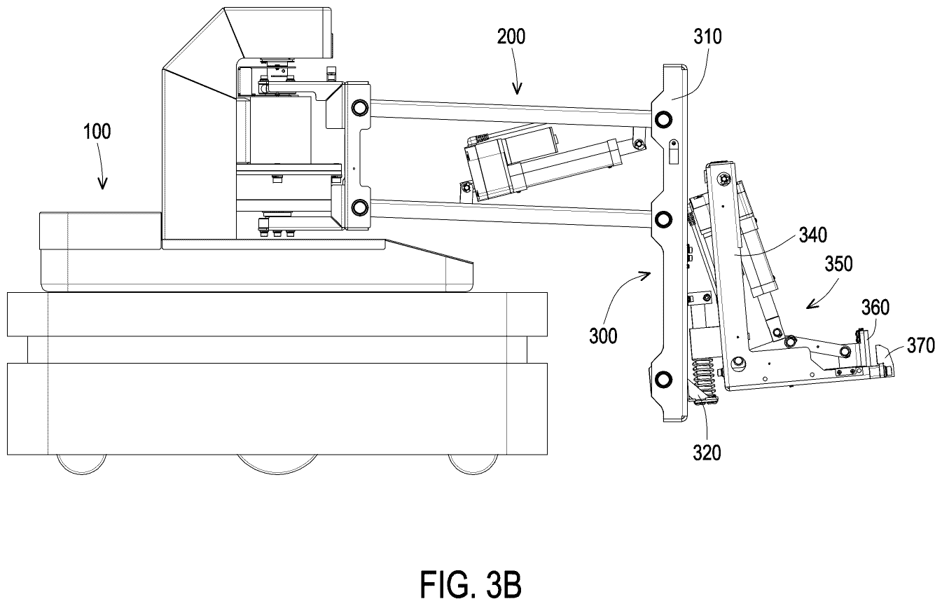

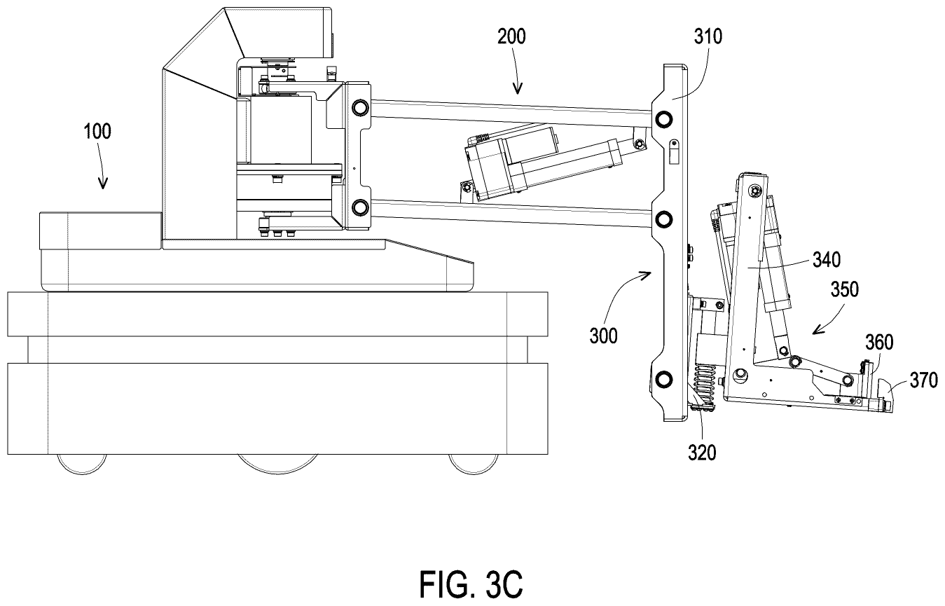

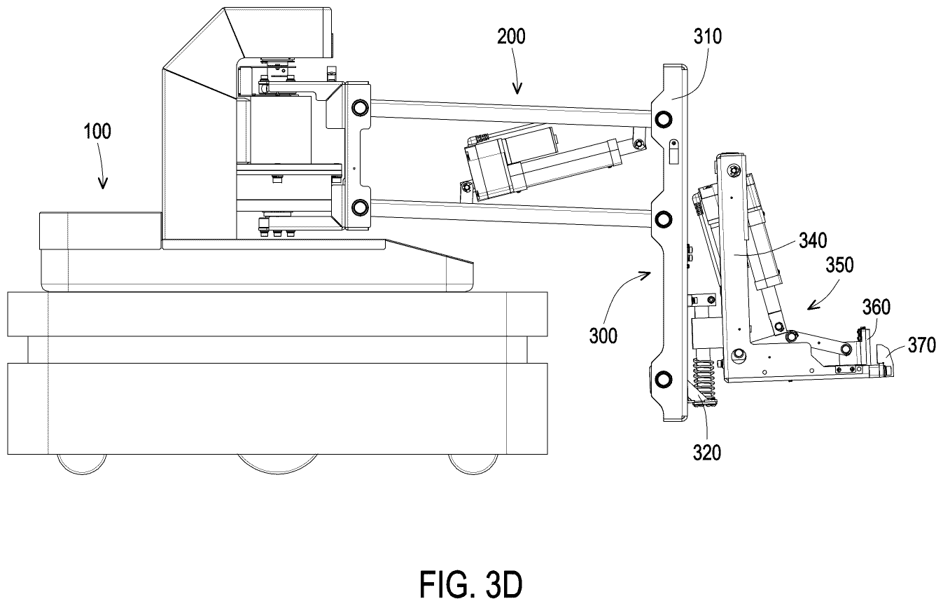

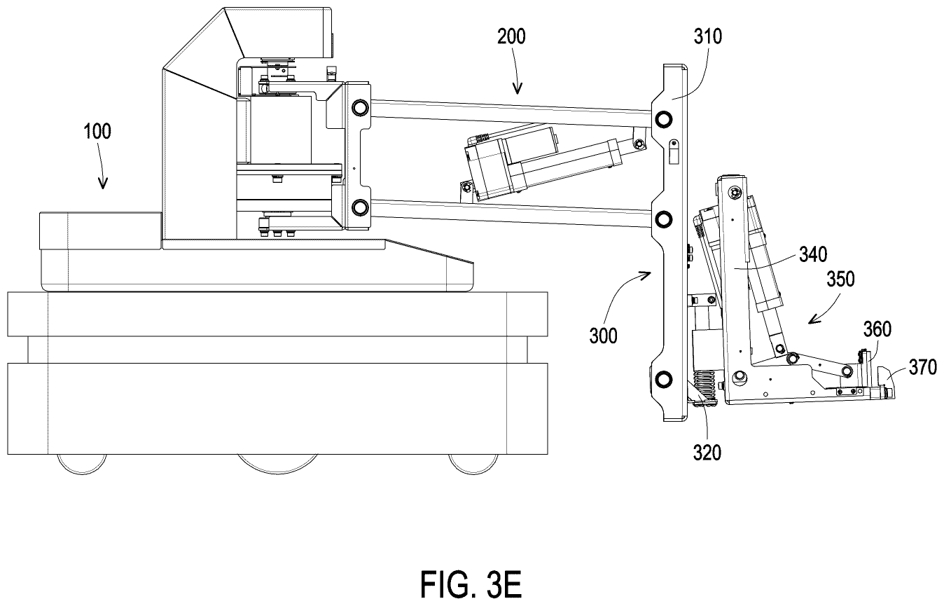

FIG. 2C is a schematic view of the gripping mechanism of FIG. 2B viewed from another perspective.

FIG. 2D is a schematic view of the gripping mechanism of FIG. 2C in another use mode. FIG. 3A is a schematic side view of the mobile robot of FIG. 1A.

FIG. 3A is a schematic side view of the mobile robot of FIG. 1A.

FIG. 3B and FIG. 3C are schematic side views of the dynamic adjustment of the angle of the gripping mechanism of FIG. 3A.

FIG. 3D and FIG. 3E are schematic side views of the dynamic adjustment of the height of the gripping mechanism of FIG. 3A.

### DESCRIPTION OF THE EMBODIMENTS

FIG. 1A and FIG. 1B are schematic views of a mobile robot viewed from two different perspectives according to an embodiment of the present disclosure. Please refer to FIG. 1A and FIG. 1B. In this embodiment, the mobile robot 10 is adaptable for automated factories, automated warehousing, automated logistics centers or other automated fields, and may accurately transport target objects to the destination according to a pre-planned path or autonomous navigation to significantly reduce manpower deployment and even achieve unmanned deployment.

In detail, the mobile robot 10 includes a moving body 100, a rotating lifting arm 200 and a gripping mechanism 300, wherein two ends of the rotating lifting arm 200 are respectively pivotally connected to the moving body 100 and the gripping mechanism 300, and the gripping mechanism 300 is configured to grab the target object to be transported, such as a roller container, but not limited thereto. On the other hand, the rotating lifting arm 200 may appropriately adjust the height position of the gripping mechanism 300 to assist in grabbing the target object, releasing the target object, lifting the target object, or lowering the target object.

Please refer to FIG. 1A and FIG. 1B. In this embodiment, the rotating lifting arm 200 includes a rotating body 210, a first lifting rod 220, a second lifting rod 230 and a driver 240, wherein the rotating body 210 is pivotally disposed on the moving body 100, and the first lifting rod 220 is parallel to the second lifting rod 230. Two ends of the first lifting rod 220 are respectively pivotally disposed on the rotating body 210 and the gripping mechanism 300, and two ends of the second lifting rod 230 are respectively pivotally connected to the rotating body 210 and the gripping mechanism 300.

On the other hand, the driver 240 is disposed between the first lifting rod 220 and the second lifting rod 230, and may be a pneumatic push rod, a hydraulic push rod or an electric push rod. Specifically, the driver 240 is pivotally disposed on the second lifting rod 230 and is pivotally connected to the first lifting rod 220. The driver 240 may push the first lifting rod 220 upward to make the first lifting rod 220, the second lifting rod 230 and the gripping mechanism 300 to ascend simultaneously. Correspondingly, the driver 240 may pull the first lifting rod 220 downward to make the first lifting rod 220, the second lifting rod 220 and the gripping mechanism 300 to descend simultaneously.

FIG. 2A and FIG. 2B are schematic views of the gripping mechanism of FIG. 1A and FIG. 1B respectively. Please refer to FIG. 1A, FIG. 1B, FIG. 2A and FIG. 2B. In this embodiment, the gripping mechanism 300 includes a first bracket 310, a second bracket 320, a first guide rod 330, a third bracket 340, an actuating module 350, a gripping block 360 and two grippers 370. In detail, the first lifting rod 220 and the second lifting rod 230 are pivotally connected to the first bracket 310, and the pivoting position of the first lifting rod 220 on the first bracket 310 is higher than the pivoting position of the second lifting rod 230 on the first bracket 310.

The second bracket 320 is connected to the first bracket 310; specifically, the second bracket 320 is pivotally connected to the first bracket 310. In details, the pivoting position of the second lifting rod 230 on the first bracket 310 is higher than the pivoting position of the second bracket 320 on the first bracket 310, and the pivoting position of the second lifting rod 230 on the first bracket 310 is located between the pivoting position of the first lifting rod 220 on the first bracket 310 and the pivoting position of the second bracket 320 on the first bracket 310.

As shown in FIG. 2A and FIG. 2B, the first guide rod 330 is fixed on the second bracket 320, and the third bracket 340 is slidably connected to the first guide rod 330. That is to say, the third bracket 340 is connected to the second bracket 320 through the first guide rod 330. On the other hand, the actuating module 350 is disposed on the third bracket 340, wherein the gripping block 360 is slidably disposed on the third bracket 340, and the gripping block 360 is connected to the actuating module 350.

Additionally, the gripping block 360 and the two grippers 370 are disposed opposite to each other, and are fixed on the terminal end of the third bracket 340 distal from the first bracket 310 and the second bracket 320. The actuating module 350 is disposed between the first guide rod 330 and the gripping block 360, and the gripping block 360 is located between the actuating module 350 and the two grippers 370.

Specifically, the second bracket 320 may rotate relative to the first bracket 310, and the first guide rod 330, the third bracket 340, the actuating module 350, the gripping block 360 and the two grippers 370 may rotate synchronously with the second bracket 320. On the other hand, the third bracket 340 may slide relative to the second bracket 320, and the actuating module 350, the gripping block 360 and the two grippers 370 may slide synchronously with the third bracket 340.

As shown in FIG. 2A and FIG. 2B, the first guide rod 330 may be configured to determine the sliding direction of the third bracket 340, and the third bracket 340 is adapted to slide relative to the second bracket 320 along the first direction D1 under the guidance of the first guide rod 330. On the other hand, the actuating module 350 is adaptable to drive the gripping block 360 to slide on the third bracket 340 along the second direction D2 perpendicular to the first direction D1, for example, to slide close to the two grippers 370 to clamp and fix the target object between the gripping block 360 and the two grippers 370, alternatively, to slide away from the two grippers 370 to release the target object.

The gripping mechanism 300 further includes a second guide rod 380 fixed on the third bracket 340, wherein the gripping block 360 is slidably connected to the second guide rod 380, and the first guide rod 330 is perpendicular to the second guide rod 380. Specifically, the second guide rod 380 may be configured to determine the sliding direction of the gripping block 360, and the gripping block 360 is adapted to slide on the third bracket 340 along the second direction D2 under the guidance of the second guide rod 380.

As shown in FIG. 2A and FIG. 2B, the actuating module 350 includes an actuating push rod 351, a first driven rod 352 and a second driven rod 353, wherein the actuating push rod 351 is pivotally connected to the third bracket 340, and may be a pneumatic push rod, a hydraulic push rod or an electric push rod. On the other hand, two ends of the first driven rod 352 are respectively pivotally connected to the actuating push rod 351 and the third bracket 340, and two ends of the second driven rod 353 are respectively pivotally connected to the first driven rod 352 and the gripping block 360. That is to say, the first driven rod 352 is located between the first guide rod 330 and the second driven rod 353, and the second driven rod 353 is located between the first driven rod 352 and the gripping block 360. In addition, the gripping block 360 is located between the second driven rod 353 and the two grippers 370.

The actuating push rod 351 may push the first driven rod 352 downward, and the first driven rod 352 drives the second driven rod 353 to make the gripping block 360 to be pushed toward the two grippers 370 by the second driven rod 353. In contrast, the actuating push rod 351 may pull the first driven rod 352 upward, and the first driven rod 352 drives the second driven rod 353 to make the gripping block 360 to be pulled away from the two grippers 370 by the second driven rod 353. That is to say, the actuating module 350 is configured to control the distance between the gripping block 360 and the two grippers 370 to clamp the fixed target object or release the target object.

Please refer to FIG. 1A, FIG. 1B, FIG. 2A and FIG. 2B. The rotating body 210 may include a locking element (not shown) configured to lock the rotating body 210 on the moving body 100 or to release the locking relationship of the rotating body 210 on the moving body 100. In detail, since the sensor 303 may detect the state between the gripping block 360 and the two grippers 370, when the sensor 303 detects that there is an object (i.e., at least part of the target object) between the gripping block 360 and the two grippers 370, it may be determined that the gripping mechanism 300 is ready to grasp the target object. Under the circumstances, before the grippers 370 is in contact with the target object, the locking element releases the locking relationship of the rotating body 210 on the moving body 100 to make the rotating body 210 to rotate relative to the moving body 100 and drive relevant elements to be in contact with the target object. In this way, the two grippers 370 may grab the target object within a slight allowable offset to avoid damage caused by collision during the process of gripping the target object. For example, the mechanism used by the locking element to lock the rotating body 210 on the moving body 100 may include a snapping, fitting or magnetic attraction mechanism, but the disclosure is not limited thereto.

FIG. 2C is a schematic view of the gripping mechanism of FIG. 2B viewed from another perspective. FIG. 2D is a schematic view of the gripping mechanism of FIG. 2C in another use mode. Please refer to FIG. 2B and FIG. 2C. In this embodiment, the two grippers 370 are arranged in parallel on the terminal end of the third bracket 340 distal from the first bracket 310 and the second bracket 320, and the distance S between the two grippers 370 may be greater than the width W of the gripping block 360 to increase the stability of clamping or grasping the target object.

Further, the gripping block 360 includes a body 361 connected to the second driven rod 353 of the actuating module 350 and a bump 362 fixed on the body 361, wherein the body 361 is slidably connected to the second guide rod 380, and the bump 362 is disposed between the body 361 and the two grippers 370. On the other hand, the bump 362 is detachably fixed on one side of the body 361 facing the two grippers 370, and the bump 362 may be configured in a longitudinal manner as shown in FIG. 2C or in a horizontal manner as shown in FIG. 2D depending on the requirement of clamping or gripping.

As shown in FIG. 2C, the bump 362 is arranged longitudinally, and the extension direction E of the bumps 362 is perpendicular to the parallel direction D3 of the two grippers 370. As shown in FIG. 2D, the bump 362 is arranged horizontally, and the extension direction E of the bump 362 is parallel to the parallel direction D3 of the two grippers 370.

In other examples, the number of the grippers 370 may be three or more, and the grippers 370 may be arranged at equal intervals in parallel on the terminal end of the third bracket 340 distal from the first bracket 310 and the second bracket 320.

FIG. 3A is a schematic side view of the mobile robot of FIG. 1A. As shown in FIG. 2A, FIG. 2B and FIG. 3A, the connecting line L between the pivot axis 352a of the first driven rod 352 on the third bracket 340 and the pivot axis 353a of the second driven rod 353 on the gripping block 360 is parallel to the second guide rod 380 or the second direction D2. On the other hand, the connection line L between the pivot axis 352a of the first driven rod 352 on the third bracket 340 and the pivot axis 353a of the second driven rod 353 on the gripping block 360 is higher than the pivot axis 320a of the second bracket 320 on the first bracket 310. Such a design may not only firmly clamp and fix the target object between the gripping block 360 and the two grippers 370, but also prevent the target object from falling over or decoupling during transportation.

As shown in FIG. 2B, the gripping mechanism 300 further includes a sensor 303 fixed on the gripping block 360, wherein the sensor 303 may be an infrared distance sensor, a laser distance sensor or other types of distance sensors, and faces the two grippers 370. Furthermore, the sensor 303 may be configured to detect the state between the gripping block 360 and the two grippers 370 to ensure that the target object may be firmly clamped and fixed between the gripping block 360 and the two grippers 370.

Please refer to FIG. 2A, FIG. 2B and FIG. 3A. The gripping mechanism 300 further includes a compression spring 301 and a tension spring 302. The compression spring 301 is sleeved on the first guide rod 330, and two ends of the compression spring 301 are in contact with the second bracket 320 and the third bracket 340 respectively. Furthermore, the compression spring 301 may support the third bracket 340 and provide sufficient buffering force for the ascending and descending of the third bracket 340 relative to the second bracket 320.

Two ends of the tension spring 302 are respectively connected to the first bracket 310 and the second bracket 320, and two ends of the second bracket 320 are respectively connected to the tension spring 302 and pivotally connected to the first bracket 310. On the other hand, the tension spring 302 is higher than the compression spring 301 and is higher than the connection line L between the pivot axis 352a of the first driven rod 352 on the third bracket 340 and the pivot axis 353a of the second driven rod 353 on the gripping block 360. Furthermore, since the second bracket 320, the third bracket 340, the gripping block 360 and the two grippers 370 rotate synchronously, the tension spring 302 may not only control the pre-lifting angle of the second bracket 320, but also control the initial clamping angle of the gripping block 360 and the two grippers 370.

Please refer to FIG. 2A and FIG. 2B. The gripping mechanism 300 further includes a screw 390a and an adjusting bracket 390b. The adjusting bracket 390b is screwed to the first bracket 310 through the screw 390a, and the tension spring 302 is connected to the first bracket 310 through the adjusting bracket 390b. Therefore, operation staff may move the adjusting bracket 390b by turning the screw 390a, and adjust the spring tension of the tension spring 302 by the adjusting bracket 390b.

FIG. 3B and FIG. 3C are schematic side views of the dynamic adjustment of the angle of the gripping mechanism of FIG. 3A. Please refer to FIG. 2A and FIG. 3A to FIG. 3C. When the mobile robot 10 is transporting the target object, the second bracket 320, the third bracket 340, the gripping block 360 and the two grippers 370 may instantly adapt to changes in the terrain to produce appropriate dynamic adjustments of angle to prevent the target object from being detached accidentally due to impact, obstruction, vibration or other external forces or objects during transportation, thereby preventing the mobile robot 10 and the target object from falling over and improving the efficiency and reliability of automated transportation.

In this embodiment, the so-called dynamic adjustment of angle means that the second bracket 320, the third bracket 340, the gripping block 360 and the two grippers 370 may rotate synchronously relative to the first bracket 310 when being subjected to external forces or objects to absorb external forces. In this way, not only that it is possible to prevent the target object from being accidentally detached from the gripping block 360 and the two grippers 370, but also to prevent the mobile robot 10 and the target object from falling over.

FIG. 3D and FIG. 3E are schematic side views of the dynamic adjustment of the height of the gripping mechanism of FIG. 3A. Please refer to FIG. 2B, FIG. 3A, FIG. 3D and FIG. 3E. When the mobile robot 10 is transporting the target object, the third bracket 340, the gripping block 360 and the two grippers 370 may instantly adapt to changes in the terrain to produce appropriate dynamic adjustments of height to prevent the target object from being accidentally detached due to impact, obstruction, vibration or other external forces or objects during transportation, thereby preventing the mobile robot 10 and the target object from falling over and improving the efficiency and reliability of automated transportation.

In this embodiment, the so-called dynamic adjustment of the height means that the third bracket 340, the gripping block 360 and the two grippers 370 may slide synchronously relative to the second bracket 320 when being subjected to external force or objects to absorb the external force. In this way, not only that it is possible to prevent the target object from being accidentally detached from the gripping block 360 and the two grippers 370, but also to prevent the mobile robot 10 and the target object from falling over.

To sum up, when the mobile robot is transporting the target object, the gripping block and the two grippers in the gripping mechanism may firmly grasp the target object and instantly adapt to changes in the terrain to produce appropriate dynamic adjustment of angle or dynamic adjustment of height to prevent the target object from being accidentally detached from the gripping mechanism, and to prevent the mobile robot and the target object from falling over, thereby significantly improving the efficiency and reliability of automated transportation.

Although the present disclosure has been disclosed above through embodiments, it is not intended to limit the present disclosure. Anyone with ordinary knowledge in the technical field may make some modifications and refinement without departing from the spirit and scope of the present disclosure. Therefore, the scope to be protected by the present disclosure shall be determined by the appended claims.

What is claimed is:

1. A gripping mechanism, comprising:
a first bracket;
a second bracket pivotally connected to the first bracket;
a third bracket connected to the second bracket;
an actuating module disposed on the third bracket;
a gripping block slidably disposed on the third bracket, and connected to the actuating module; and
two grippers fixed on a terminal end of the third bracket distal from the first bracket and the second bracket, wherein the gripping block is disposed between the actuating module and the two grippers, and the actuating module is adapted to drive the gripping block to slide close to or away from the two grippers.

2. The gripping mechanism according to claim 1, wherein the two grippers are arranged in parallel on the terminal end of the third bracket distal from the first bracket and the second bracket, and a distance between the two grippers is greater than a width of the gripping block.

3. The gripping mechanism according to claim 1, wherein the gripping block comprises a body connected to the actuating module and a bump detachably fixed on the body, and the bump is disposed between the body and the two grippers.

4. The gripping mechanism according claim 3, wherein the two grippers are arranged in parallel on the terminal end of the third bracket distal from the first bracket and the second bracket, and an extending direction of the bump is perpendicular or parallel to a parallel direction of the two grippers.

5. The gripping mechanism according to claim 1, further comprising a first guide rod fixed on the second bracket, wherein the second bracket is pivotally connected to the first bracket, and the third bracket is slidingly connected to the first guide rod, the actuating module is disposed between the first guide rod and the gripping block, wherein the third bracket is adapted to slide along a first direction, and the actuating module is adapted to drive the gripping block to slide along a second direction perpendicular to the first direction.

6. The gripping mechanism according to claim 5, wherein the actuating module comprises:
an actuating push rod pivotally connected to the third bracket;
a first driven rod, wherein two ends of the first driven rod are respectively pivotally connected to the actuating push rod and the third bracket; and
a second driven rod, wherein two ends of the second driven rod are respectively pivotally connected to the first driven rod and the gripping block.

7. The gripping mechanism according to claim 6, wherein a connection line between a pivot axis of the first driven rod on the third bracket and a pivot axis of the second driven rod on the gripping block is parallel to the second direction.

8. The gripping mechanism according to claim 6, wherein a connection line between a pivot axis of the first driven rod on the third bracket and a pivot axis of the second driven rod on the gripping block is higher than a pivot axis of the second bracket on the first bracket.

9. The gripping mechanism according to claim 5, further comprising a second guide rod fixed on the third bracket, wherein the gripping block is slidably connected to the second guide rod, and the first guide rod is perpendicular to the second guide rod.

10. The gripping mechanism according to claim 5, further comprising a compression spring sleeved on the first guide rod, wherein two ends of the compression spring are in contact with the second bracket and the third bracket respectively.

11. The gripping mechanism according to claim 5, further comprising a tension spring, wherein two ends of the tension spring are respectively connected to the first bracket and the second bracket, and two ends of the second bracket are respectively connected to the tension spring and pivotally connected to the first bracket.

12. The gripping mechanism according to claim 11, further comprising a screw and an adjusting bracket, wherein the adjusting bracket is screwed to the first bracket through the screw, and the tension spring is connected to the first bracket through the adjusting bracket.

13. The gripping mechanism according to claim 1, further comprising a sensor fixed on the gripping block, and the sensor faces the two grippers.

14. A mobile robot, comprising:
a moving body;
a rotating lifting arm pivotally connected to the moving body; and
a gripping mechanism comprising:
a first bracket pivotally connected to the rotating lifting arm;
a second bracket pivotally connected to the first bracket;
a third bracket connected to the second bracket;
an actuating module disposed on the third bracket;
a gripping block slidably disposed on the third bracket, and connected to the actuating module; and
two grippers fixed on a terminal end of the third bracket distal from the first bracket and the second bracket, wherein the gripping block is disposed between the actuating module and the two grippers, and the actuating module is adapted to drive the gripping block to slide close to or away from the two grippers.

15. The mobile robot according to claim 14, wherein the two grippers are arranged in parallel on the terminal end of the third bracket distal from the first bracket and the second bracket, and a distance between the two grippers is greater than a width of the gripping block.

16. The mobile robot according to claim 14, wherein the gripping block comprises a body connected to the actuating module and a bump detachably fixed on the body, and the bump is disposed between the body and the two grippers.

17. The mobile robot according to claim 16, wherein the two grippers are arranged in parallel on the terminal end of the third bracket distal from the first bracket and the second bracket, and an extending direction of the bump is perpendicular or parallel to a parallel direction of the two grippers.

18. The mobile robot according to claim 14, wherein the gripping mechanism further comprises a first guide rod fixed on the second bracket, the second bracket is pivotally connected to the first bracket, and the third bracket is slidingly connected to the first guide rod, the actuating module is disposed between the first guide rod and the gripping block, wherein the third bracket is adapted to slide along a first direction, and the actuating module is adapted to drive the gripping block to slide along a second direction perpendicular to the first direction.

19. The mobile robot according to claim 18, wherein the actuating module comprises:
an actuating push rod pivotally connected to the third bracket;
a first driven rod, wherein two ends of the first driven rod are respectively pivotally connected to the actuating push rod and the third bracket; and
a second driven rod, wherein two ends of the second driven rod are respectively pivotally connected to the first driven rod and the gripping block.

20. The mobile robot according to claim 19, wherein a connection line between a pivot axis of the first driven rod on the third bracket and a pivot axis of the second driven rod on the gripping block is parallel to the second direction.

21. The mobile robot according to claim 19, wherein a connection line between a pivot axis of the first driven rod on the third bracket and a pivot axis of the second driven rod on the gripping block is higher than a pivot axis of the second bracket on the first bracket.

22. The mobile robot according to claim 18, wherein the gripping mechanism further comprises a second guide rod fixed on the third bracket, wherein the gripping block is slidably connected to the second guide rod, and the first guide rod is perpendicular to the second guide rod.

23. The mobile robot according to claim 18, wherein the gripping mechanism further comprises a compression spring sleeved on the first guide rod, and two ends of the compression spring are in contact with the second bracket and the third bracket respectively.

24. The mobile robot according to claim 18, wherein the gripping mechanism further comprises a tension spring, wherein two ends of the tension spring are respectively connected to the first bracket and the second bracket, and two ends of the second bracket are respectively connected to the tension spring and pivotally connected to the first bracket.

25. The mobile robot according to claim 24, wherein the gripping mechanism further comprises a screw and an adjusting bracket, wherein the adjusting bracket is screwed to the first bracket through the screw, and the tension spring is connected to the first bracket through the adjusting bracket.

26. The mobile robot according to claim 14, wherein the gripping mechanism further comprises a sensor fixed on the gripping block, and the sensor faces the two grippers.
